(19) United States
(12) Patent Application Publication
(10) Pub. No.: US 2002/0041139 A1
(43) Pub. Date: Apr. 11, 2002

(54) Portable Lamp With Adjustment Device To Obtain Different Emitted Light Cones

(76) Inventor: HARALD OPOLKA, SOLINGEN (DE)

Correspondence Address: FILDES & OUTLAND, ATTN CHRISTOPHER J FILDES, 20916 MACK AVENUE, SUITE 2, GROSSE POINTE WOODS, MI, 48236

(21) Appl. No.: 09/206,038

(22) Filed: Dec. 4, 1998

(30) Foreign Application Priority Data
Dec. 8, 1997 (DE) 197 54 444.4
May 30, 1998 (DE) 298 09 771.0

(51) Int. Cl. H01K 1/00

(52) U.S. Cl. 313/316; 313/115; 313/236; 313/272

(57) ABSTRACT

A portable lamp with adjustment device to obtain different emitted light cones includes a light source received within a concave reflector. The light source includes at least two separately switchable incandescent filaments operatively connected to a power source, which are arranged within the light source to generate a desired light cone. By way of example, according to the invention, a filament intended to generate a small angled light cone, i.e. for far distance illumination, draws greater power from the power source than a filament intended to generate a wide angled light cone. To this end, each of the filaments has different illuminous efficiencies. An additional laser light source, electronic flash unit controlled by the light source may also be provided.

### DESCRIPTION

The invention concerns a portable lamp or table standard lamp with an adjustment device to obtain different light cones; in particular a pocket lamp whose light source is situated in a concave reflector.

The way things stand technologically, pocket lamps of the above-mentioned kind have a reflector which is contained in the lamp head and wich can be shifted on a longitudinal axis with regard to the light source (a light bulb) placed near the reflector focus. This shift can be effected either by a translatory pushing motion via a guidance running on a longitudinal axis, or by a turning motion, in which the reflector base is only partly movable, viz according to the thread pitch. The effect attainable by this relative spacing alteration between reflector and bulb consists in a change of shape of the emitted light cone. As a rule, in the boundary position, which is restricted by a mechanical stop, either a light bundle of basically parallel beams for full-beam illumination, or a light cone with wide cone angle for close-range illumination (like a wide-angle lens) is emitted. The same effect is obtained if the reflector is inflexibly fastened to the lamp case while the relative position of the bulb within the reflector can be changed instead via a slide or something similar. The change of shape of the emitted light bundle results from the reflection on the internal surface of the reflector of the beams sent out by the light bulb. A basically parallel light beam emission is achieved if the light bulb is situated in the focus of the concave mirror.

Mostly, pocket lamps of the aforesaid kind are supplied with voltage by small accumulators, the case interior having appropriately shaped battery containers. Alternatively, hand lamps are known which are fed by external voltage supply, eg. by an automobile battery, whose voltage can be taken off at a socket which is situated in the car interior and which mostly accommodates a so-called cigarette lighter.

Besides that, there are table standard lamps which have eg. a halogen- or xenon-lamp inside of a reflector and are covered at the emission side with a glass pane or lens. If the lens is arranged along the emission axis in such a way that it is longitudinally traversable, a variable divergence performance of the light emission can be achieved by the relative alteration of the distance between bulb and lens.

It is the task of the present invention to simplify the handling of light cone alteration with the above-mentioned lamp and for that to specify technical devices which are safe, simply built and manufacturable without a lot of expenditure. This task is fulfilled by the portable lamp or table standard lamp as claimed in claim 1. According to the invention, it is characterized by having at least two separately switchable filaments (incandescent filaments) as light sources. Two or more filaments, or light-emitting glow-discharge bodies respectively, require to be put in different places within the concave reflector. This in turn causes the light beams coming from different filaments and sent to one point of the reflector to hit with incidence angles of different size, which also means that the reflecting angles (accompanying, and of the same size as, the incidence angles) have different sizes. As a consequence, by choosing the position of different filaments, different light cones can be generated. In the simplest case of application, this means that one filament is situated in the focus of the concave reflector, so that the light which it emits sideways and backwards and which is reflected by the concave reflector turns out as a basically parallel light beam bundle. The second filament will, depending on its location, generate a different light cone, eg. one with a wider angle but a shorter range. The fact that the filaments have separate circuits enables the user of the pocket lamp to easily alter the luminance characteristics of the lamp by operating assigned circuit closers and breakers or a polystage switch. In comparison with the pocket lamps which have up to now been available on the market, this is advantageous, because said switchings can be carried out with one hand, so that awkward turning or shifting is no longer necessary.

Further developments of the invention are described in the subordinate claims.

In a concrete model example, two filaments are placed on different planes, which with regard to a plane hit vertically by all beams of the light cone, are arranged parallel to each other. In other words, the two (or more, if need be) filaments are “staggered” in relation to the longitudinal axis of light. The light source situated in the focus is used for the emission of basically parallel main light, the other filament is used for generating wide light cones, which owing to their wider angle have a correspondingly lower luminance and level of illumination. Of course it is alternatively possible to arrange the filaments on a common plane side by side. With only two filaments it is already possible to create two either equally or differently great luminous efficiencies, which can be switched on at any one time, according to demand. However, the invention also includes operating possibilities which allow all existing filaments, or eg. two of three filaments, to be switched on. The filaments may be arranged either in different cases or in one case consisting of compartments with different gas fillings and/or different gas pressure.

Further variations of the lamp according to the invention are possible if a shading body is placed in the vicinity of at least one filament. This shading body blocks certain beam directions towards the concave reflector, so that different lighting patterns can be generated, depending on the convex internal surface shape of the reflector in connection with the shading body, and depending on the switched-on filament. The concept of “shading body” is understood to include also those bodies whose side facing the filament is built as a reflector. Thereby, depending on the surface shape of the reflector, the emitted light cones can be specifically influenced.

Just as well, additional reflectors can be placed in the interior space of the concave reflector and can be assigned to the existing light sources. Using two or more filaments considerably increases the amount of variation possibilities combining the additional filament or filaments with assigned reflectors, shading bodies etc. This more than compensates for the missing analogue adjustment possibility of the lamp according to the invention.

In a further development of the invention, the lamp body has a ring coating which only transmits monochrome light and is situated level with a filament. This ring may be tinted for example red or yellow, so that the lamp in question can be used as safety lamp in case only one filament, i.e. the one situated level with the ring, is switched on. This may possibly be supported if said light bulb could also be switched to flashing light.

The concave reflector may also be developed as parabolic mirror.

In a further variant of the invention, the lamp has at least two light-emitting diodes (LEDs) on its outer surface; their position should be diametrically opposite at the lamp case. If there are three LEDs, the angular distance is 120 [symbol] . The LEDs—if switched on—perform the task of making a switched-off lamp put down in the dark immediately visible. The LEDs can be operated at a minimum current, so they do not put pressure on the battery of a portable lamp, or only insignificantly so. Such a portable lamp is useful for hunters, fishermen or other people who have to carry out certain operations in the dark during which the lamp has to be switched off and put aside.

It is equally possible to put a colour filter either completely or partially around one of the filaments and thereby make it emit monochrome light accordingly. In case different light bulbs with one filament each are used, this can be carried out by colouring the glass bodies.

In case one wants first of all to fixate point accurately the area to be illuminated without switching on a filament (for instance if one does not want to attract attention), a further development of the invention provides the lamp with a separately or additionally switchable laser (continuous-wave laser). This kind of laser has the advantage to be able to emit a strongly focused light beam (in the optically visible region), which facilitates the accurate pointing of the lamp even before the light bulb or bulbs are switched on. The position for the laser-exit beam should preferably be in the interior of the concave reflector, as close as possible to the filament situated in the reflector focus. The direction of the central light beam emitted by the bulb should preferably run parallel to the direction of the laser beam.

Now and then it is advisable to dazzle criminal persons operating in the dark for a short time. In such a case, the laser beam serves to track down the person in question before one shines the lamp at him or her. The luminosity of a lamp can be increased considerably by employing xenon, krypton, or halogen lamps instead of filament bulbs. If the glare effect connected with this is to be heightened, an additional electronic flash unit can be provided in a further development of the invention. The unit will be switched on and off either separately or together with the laser light and/or the light bulb.

In a further development of the invention, all existing light sources (light bulb, laser and/or flash unit) are connected or connectable to the same internal or external power source. The only possible continuous-wave laser is of course one that is not damaging to health, particularly the retina (laser class 2). In the case of the electronic flash units, one can fall back upon the sets available on the market. As a rule, they consist of a flash tube, i.e. an ionic valve filled with xenon- or mercury vapour with two main electrodes and an ignition electrode, and a control circuit to initiate the flash and (if necessary) to regulate the flash intensity. The control circuit contains a flash capacitor which, by an inverter circuit and a transformer, can be charged with the amount of voltage needed to trip the flash tube.

Model examples of the invention are presented in the drawings.

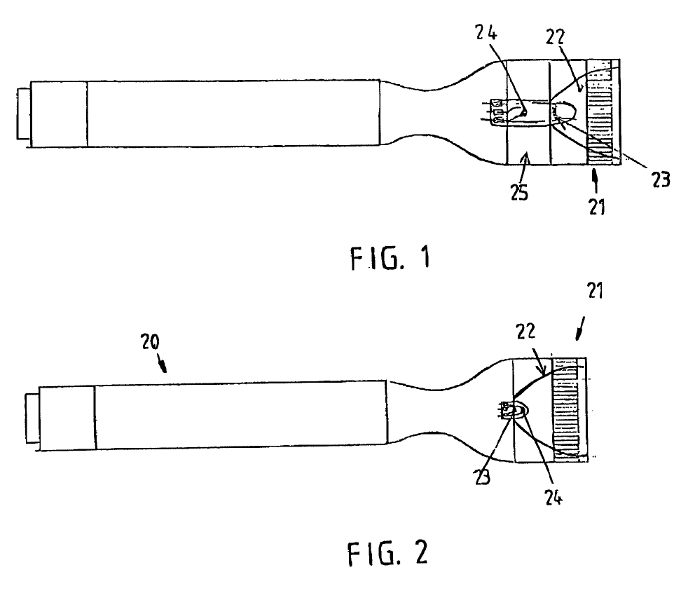

FIG. 1 and 2 both show side views of bar-shaped pocket lamps with part cross section views of the light bulbs,

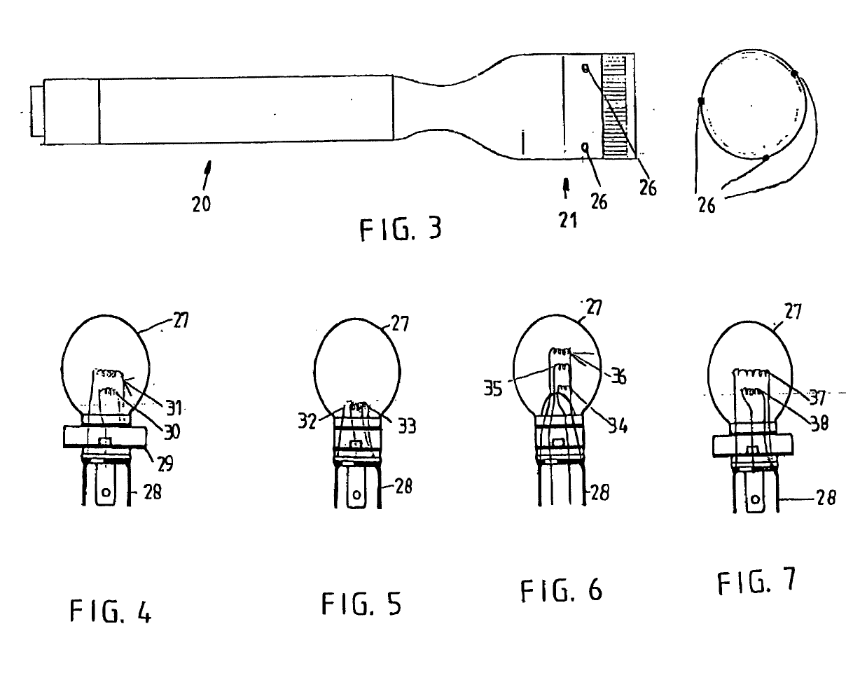

FIG. 3 shows a side view of a pocket lamp and a top view with three LEDs,

FIG. 4 to 13 present different bulb designs,

FIG. 14 and 15 show top views of light bulbs with two or three filaments respectively,

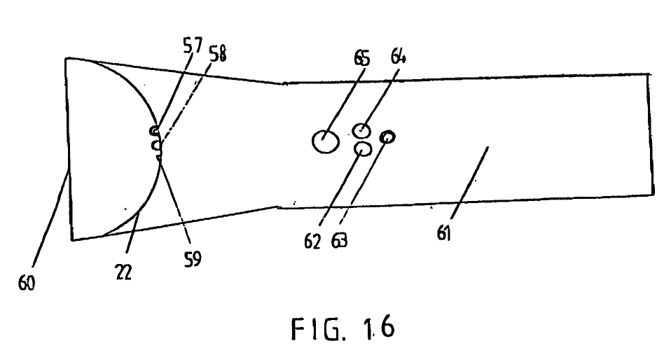

FIG. 16 presents a schematical view of a further design with laser light and a flash-light source, and

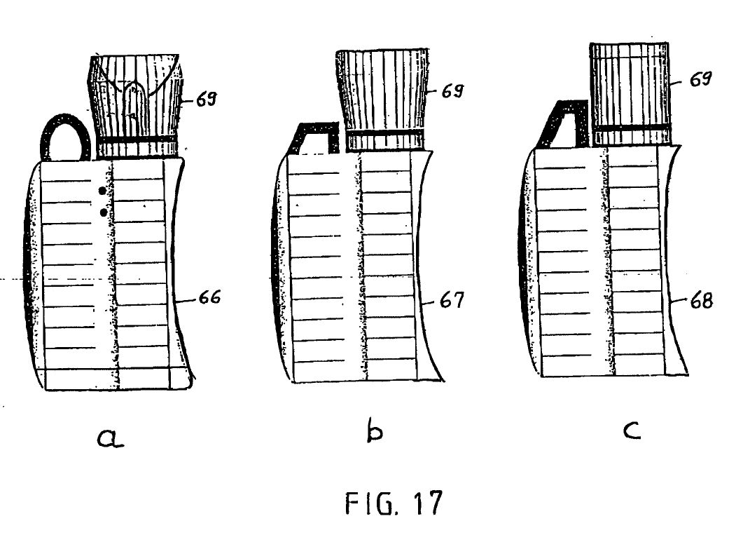

FIG. 17a to c show a model developed as camping or garden lamp.

The pocket lamp depicted in FIGS. 1 to 3 has a bar-shaped lamp body 20 with lamp head 21 and a reflector 22, which on the front end is covered by a glass plate. According to the invention, the pocket lamp in FIG. 1 has a light bulb containing two filaments 23 and 24 which are situated on different planes. The planes are in parallel position to the front cover plate which is lit through by all light cone bundles. The pocket lamp has a ring-shaped, red-tinted but light-transmitting body situated about level with the filament 24, so that the beams emitted sideways by the filament 24 are filtered and sent out as red light. In the case shown in FIG. 1, the filament 24 is placed outside of the reflector 22, so that it emits its light through the above-mentioned ring 25 only to the sides.

The model presented in FIG. 2 has a light bulb which also contains two filaments 23 and 24, but in this case both filaments are placed on different planes within the interior space of the reflector 22, so that the light emitted from the filaments 23 and 24 is reflected by the reflector inner surface with different angles of reflection, from which result different light cones. If for example filament 24 is situated in the focus of the reflector 22, the light emitted by the filament runs basically parallel, while the light emitted by filament 23 is reflected in the direction of a focus located outside of the pocket lamp. Beyond this focus, a light cone with a wide angle but low level of illumination per square unit is produced, so that the light emitted by filament 23 serves principally for close range illumination in a big area. The filaments 23 and 24 are separately switchable, i.e. either only one of them can be switched on, or both of them, if need be. In accordance with the present invention there can also be provided a polystage switch for a time-limited change-over, for one single change-over as well as for a change-over to intermittent chopped light.

On the outer surface of its lamp head, the pocket lamp shown in FIG. 3 has three LEDs 26, which can be switched to continuous operation. These LEDs make the switched-off pocket lamp instantly visible in the dark.

FIGS. 4 to 15 present different filament arrangements and lamp configurations within the light bulbs. The constructions concerned may alternatively also be carried out by means of several separate light bulbs with only one filament each, but this has the disadvantage that two receptacles each have to be available inside of the lamp.

The design in FIG. 4 shows a light bulb with glass body 27, plug contacts 28, and cap 29. The filaments 30 and 31 are “staggered” and have the same power consumption, eg. 10 w.

The filaments 32 and 33, shown in FIG. 5 in a light bulb built similar to the one in FIG. 4, however, are parallel, arranged side by side, as becomes apparent from the top view in FIG. 14.

The light bulb in FIG. 6 has on the whole three staggered filaments 34, 35, and 36, each with different power consumption, viz. the energy-saving filament 34 only glows with 1 w, while the others glow with 6 w and 10 w respectively.

The design in FIG. 7 corresponds to the one in FIG. 4 on the understanding that the filaments 37 and 38 have different power consumptions of 5 w and 10 w respectively.

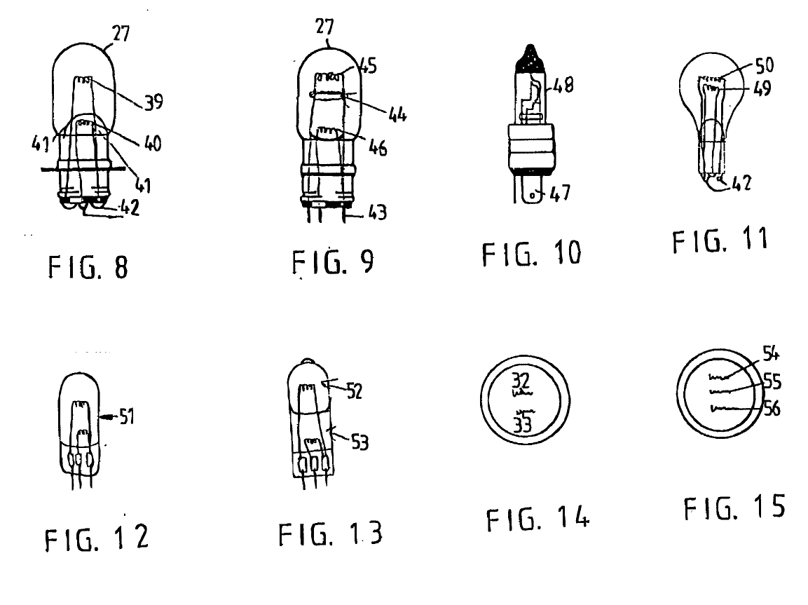

Instead of having plugs like the light bulbs in FIG. 4 to 7, the bulb in FIG. 8 possesses contact plates 42. In this case, the cap has to be arrested by a bayonet socket, a device well-known in principle. The filaments 39 and 40 have different power consumptions of 6 w and 2 w respectively. Filament 40 is additionally covered by a tinted glass body 41. The light emitted by filament 40 if switched on consequently appears to be monochrome according to the filtering glass 41.

The light bulb in FIG. 9 has pin contacts through which filaments 45 and 46 are supplied with voltage. In addition, a reflector 44 is placed between filaments 46 and 45. It reflects the light which filament 45 emits backwards, i.e. in the direction of the cap. The shape of reflector 44 can be flat, convex, bevel-edged, or however is necessary to obtain the reflection pattern desired.

FIG. 10 presents a halogen lamp with a lamp body 48 filled with halogen, and with plug contacts 47.

The light bulb in FIG. 11 basically corresponds to the one in FIG. 8, on the understanding that in this case, the “colour filter” 41 is omitted. The filaments 49 and 50 are arranged within short distance of each other and may have different light emitting capacities/ power consumptions.

The examples of light bulb 51 in FIG. 12 and of the bulb in FIG. 13 are to show that the interior space of the glass containing the filaments can be built either as a single chamber with only one gas filling, or as two-chamber system 52, 53 with different gas fillings.

FIG. 14 and 15 show top views of light bulbs with two filaments 32, 33, or three filaments 54 to 56 respectively, all of which are arranged side by side, and may be arranged either on one plane or on different planes in staggered fashion.

FIG. 16 is to explain a further variant of the invention. On its front end, the pocket lamp has a glass plate 60, a reflector, and a bar-shaped lamp case 61. A light bulb 58, built as twin- or multifilament lamp, a flash bulb 57, and a laser light source 59 are placed side by side. The laser 59 runs parallel to the optical axis of the light cone originating from bulb 58. The flash bulb and also the laser light source have the smallest possible distance to bulb 58. All existing lighting sources (light bulb, laser light source, and flash bulb) are powered by a common current source, in this case by batteries or rechargeable accumulators contained in a battery case. Four engageable and disengageable pressure switches 62 to 65 are provided for switching on the above-mentioned light sources 57, 58, and 59. Through these switches, the filaments can be put into operation alternatingly or together; further switches serve to trigger off the flashing light pulse or activate the laser light source respectively. Further switches can be provided depending on desired change-over possibilities.

A special application of the pocket lamp presented in FIG. 16 arises if one has to corner criminally acting persons; but also if one has to do without the usual spot lamps, eg. in security areas including military areas where one does not want to attract any attention, or as little attention as possible. The laser serves for fixating the target. As soon as the target is lit, the flash bulb and/or the filament or filaments can be switched on.

Furthermore, the lamp presented in FIG. 16 may also be used as “optical finger” at slide projection or film shows by switching on only the laser light source and directing the laser beam at the aim-point in the picture.

The advantage of light bulbs with several filaments consists in the fact that even if one filament fails, the lamp is still able to work with its second or third filament. The different filaments have different light output, if necessary in order to suit power demand to need. The polystage switch of the pocket lamps makes possible both a quasi point-shaped illumination as well as the generation of a wide light cone—all this without awkward turning or pushing operations at the reflector head, as is the case with well-known models corresponding to the state of technology.

Within the framework of the present invention, any kind of modification of the described and presented models is of course possible, furthermore there may be light bulbs containing four or more filaments with the same or different power consumption and with any arrangement within the reflector and with or without additional reflectors, so that light cone illumination patterns and -types can be generated as required. The LEDs described above or a ring emitting coloured light facilitate the use of the pocket lamp as signal lamp, if need be in intermittent mode of operation. Electronically controlled change-overs between alternatively full beam illumination and close range illumination are also included in the invention.

A special advantage arises from the fact that the case of the pocket lamp can be manufactured as single-piece cast-iron body, eg. also in cylindrical shape, i.e. without offset lamp head. This considerably reduces production costs. Added to this is the fact that the lamp can conveniently be operated with one single hand and thereby enables a very fast change-over from close range to full beam illumination. In well-known models corresponding to the state of technology, a certain “shaking” of the light cone can be observed when the lamp head is turned manually. In the lamp according to the invention this is avoided by providing a switch for working the change-over. Infinitely many lighting variations fitted to need can be carried out with the help of different filters, reflectors, tinted rings, etc. The use of filaments with low power consumption prolongs service life in particular, because electricity can be saved appropriately without having to do without lighting. This especially goes for the employment of LEDs which indicate the place where a pocket lamp has been put down in the dark without great power consumption.

The construction variants presented in FIG. 17a to c are particularly practicable in the area of camping or as garden lighting. The portable lamp consists of a case 66, 67, or 68 which can be put down and has a carrier device. The lamp itself has a lamp head 69 consisting of transparent material, so that an all-round illumination, eg. as table lighting, is possible if the light is switched on. Depending on the luminous intensity requested, either one or both of the two existing filaments can be activated.

1. Portable lamp or table standard lamp with adjustment device to obtain different emitted light cones, in particular pocket lamp (20) with a light source situated within a concave reflector (22), characterized in that as light source, there are at least two separately switchable filaments (incandescent filaments) (23, 24; 30, 31; 32, 33; 34, 35, 36; 37, 38; 39, 40; 45, 46; 49, 50; 54, 55, 56):

2. Lamp as claimed in claim 1, characterized in that at least two filaments are situated on different planes, which are arranged parallel to each other with regard to a plane transilluminated vertically by all light cone beams.

3. Lamp as claimed in claim 1, characterized in that at least two filaments (32, 33) are placed on a common plane, which is parallel to the plane transilluminated vertically by all beams of the light cone.

4. Lamp as claimed in any of claims 1 to 3, characterized in that the filaments (32, 33) have the same luminous efficiency if arranged on one plane; if arranged on different planes, the filaments have different luminous efficiencies.

5. Lamp as claimed in any of claims 1 to 4, characterized in that the filaments are situated in different housings or in one housing containing chambers (52, 53) with different gas fillings and/or different gas pressure.

6. Lamp as claimed in any of claims 1 to 5, characterized in that a shading body (44) is situated in the vicinity of at least one filament.

7. Lamp as claimed in claim 6, characterized in that the side of the shading body (44) facing the filament is developed as reflector.

8. Lamp as claimed in any of claims 1 to 7, characterized in that besides the concave reflector (22) and possibly the shading body (44), there is at least one further reflector situated in the interior space of the concave reflector.

9. Lamp as claimed in claim 8, characterized in that the lamp body has a coating surface (25), which allows only monochrome light to pass and is situated level with a filament (24).

10. Lamp as claimed in any of claims 1 to 9, characterized in that the hollow reflector (22) has a parabolic shape.

11. Lamp as claimed in any of claims 1 to 10, characterized in that at least two light-emitting diodes (26) are situated on the outer surface of the lamp.

12. Lamp as claimed in any of claims 1 to 11, characterized in that at least one filament (40) is completely or partially surrounded by a colour filter (41).

13. Lamp as claimed in any of claims 1 to 12, characterized by a separate or additionally switchable laser light source (continuous-wave laser) (59).

14. Lamp as claimed in any of claims 1 to 13, characterized by an additionally provided electronic flash unit (57), which can be controlled either separately or together with one of the two remaining light sources (58, 59).

15. Lamp as claimed in any of claims 1 to 14, characterized by such an arrangement of the laser light source (59) and the light bulb (58), as well as possibly the flash bulb (57), as causes the central axis beam of the light bulb, the laser beam and/or the flash cone to run parallel.

16. Lamp as claimed in any of claims 1 to 15, characterized in that all light sources are connected or connectable with the same internal or external power source.
